(19) United States
(12) Patent Application Publication
(10) Pub. No.: US 2012/0318951 A1
(43) Pub. Date: Dec. 20, 2012

(54) HYDRO-ELASTIC OPERATION MEMBER FOR A BEARING, HYDRO-ELASTIC BEARING, AND METHOD FOR FITTING THE HYDRO-ELASTIC BEARING

(75) Inventors: Waldemar Hermann, Jossgrund (DE); Dmitry Khlistunov, Bad Soden-Salmunster (DE)

(73) Assignee: ANVIS DEUTSCHLAND GMBH, Steinau an der Strasse (DE)

(21) Appl. No.: 13/520,934

(22) PCT Filed: Nov. 10, 2010
(86) PCT No.: PCT/EP2010/006846

§ 371 Date: Aug. 24, 2012

(30) Foreign Application Priority Data
Jan. 12, 2010 (DE) 10 2010 004 381.8

(51) Int. Cl. F16F 13/12; F16M 13/02; B23P 17/00

(52) U.S. Cl. 248/565; 29/428; 267/140.13

(57) ABSTRACT

A hydro-elastic operation member is provided for a hydro-elastic bearing for mounting a motor vehicle part like an engine unit to the body of the motor vehicle, comprising a spring body, in particular made of an elastomer material, at least one hydraulic working chamber, a device for attaching the operation member to a support frame fixed to the vehicle body, and a flange facing the motor vehicle part for attaching the operation member to the motor vehicle part, wherein the hydraulic working chamber is delimited by components of the operation member without the support frame. The operation member forms a component unit insertable into the support frame, wherein the attachment device is designed for removing the operation member, attached to the support frame, from the support frame.

The invention relates to a hydro-elastic operation member that forms the main functional component of a hydro-elastic bearing for a motor vehicle part like an engine unit to be connected to the body of a motor vehicle.

For mounting of heavy motor vehicle parts like the engine-gear unit it is essential to bear and, if applicable, to dampen vertically acting loads as well as dynamic vibrational and, if applicable, transverse loads occurring for example during the passing of bends.

In this respect it is known to connect the engine-gear unit to the motor vehicle body via several elastic bearings. An example for such an elastic bearing is known from DE 20 2008 003 072, according to which an elastic bearing has a rigid flange attached to the engine-gear unit for supporting the latter. The known elastic bearing further comprises a support frame to be fixed to the motor vehicle body. An elastomeric body of the elastic bearing is provided so that the flange elastically rests on the support frame, which elastomeric body defines by its design and according to the connection a vertical main spring direction. The flange laterally and horizontally extends in transverse direction out of the support frame, wherein a protruding, freely accessible section serves to rigidly connect to the engine-gear unit. Furthermore, it is known to utilise hydro-elastic bearings, in particular for the connection of engine-gear units to the vehicle body.

It is an objective of the invention to overcome the disadvantages of the prior art, in particular to provide a hydro-elastic bearing, in particular a hydro-elastic operation member for a hydro-elastic bearing, wherein lower weight and lower storage costs are to be achieved while the functional performance of the bearing is at least maintained.

This object is achieved by the features of claim 1. Accordingly, a hydro-elastic operation member is provided for a bearing for a motor vehicle part like an engine unit or an engine-gear unit to be connected to the motor vehicle body. The hydro-elastic operation member according to the invention has a spring body, in particular made of an elastomer material, at least one hydraulic working chamber, a device for attaching the operation member to a support frame fixed to the vehicle body, and a flange facing the motor vehicle part for attaching the operation member to the motor vehicle part. According to the invention, the hydraulic working chamber is spatially delimited at the inner side in particular exclusively by components of the operation member, that is in particular without utilising the structure of the support frame. This means that the inside of the working chamber is not delimited by material of the support frame. The operation member forms an assembly component unit that is insertable into the support frame like a “filled cartridge”. Therein the attachment device is designed for detachably removing the operation member from the support frame, in particular without damaging the operation member and/or the support frame.

The measure according to the invention of separately fitting the support frame, facing the vehicle body, and a functional hydro-elastic assembly unit enables to adjust the hydro-elastic bearing for each individual case. The structure of a hydro-elastic bearing, that is the spring body and the working chamber with the dissipation effects achieved therein, which structure determines the damping and spring characteristics, is detachably insertable as a structural unit into the support frame, which is fixed to the vehicle body. For the adjustment of the hydro-elastic bearing merely the specific hydro-elastic operation member is to be inserted as a structural unit, corresponding to a cartridge, or to be replaced, if applicable. Thus, in other words, a cartridge-hydrobearing is realised that is individually adjustable at low cost and with little assembly effort.

It became apparent that with the hydro-elastic operation member which, according to the invention, is insertable into the support frame fixed to the vehicle body, a hydro-elastic bearing can be achieved that has optimum damping characteristics according to assembly situation and manufacturing lot. Therein, a large number of different types of bearings can be cost effectively provided owing to the individual usability of the support frame.

In a preferred embodiment of the invention the attachment device is formed by a closed, solid ring structure to which the spring body is moulded, in particular injection moulded in a fluid-tight manner. Preferably, in particular the spring body extends like a cone from the ring structure to the flange and delimits to a large part the working chamber.

In order to provide the working chamber with a highly variable working volume the spring body has a side facing the attachment device and facing away from the flange, which side forms an inner side of the working chamber.

Preferably, a channel plate is disposed within the working chamber, by means of which the working chamber is divided in particular into two hydraulic working compartments of essentially the same size. The hydraulic working compartments are preferably hydraulically connected to each other by at least one channel formed in the channel plate. The channel serves primarily the purpose, and is dimensioned such as to cause a resonance of the liquid to occur inside the channel for a predetermined excitation frequency, which produces the desired damping effect. In order to reduce the dynamic stiffness (hydraulic stiffening), preferably a loose disc is placed into the channel plate, which disc decouples the working compartments up to a certain excitation amplitude. Preferably, the decoupling disc is inserted into the channel and is made of rubber.

One of the hydraulic working compartments preferably faces the spring body, wherein the other working compartment faces away from the spring body.

The working compartment facing away from the spring body is partially delimited by a flexible membrane, whereby a slightly variable working volume is achieved. The flexible membrane is attached in a fluid-tight manner at the ring structure of the detachable attachment device and/or at the fluid-tight seal of the one working compartment at the throttling plate.

With respect to the working compartments delimited by the membrane, a lid is provided outside of the membrane protecting the membrane from external influences and/or serving the fluid-tight fixation of the membrane.

Preferably, the channel plate is firmly fixed at an inner side of a ring structure of the attachment device. The channel plate may be injection moulded from plastic material.

In a further development of the invention the attachment device is realised as a detachable latching or engaging mechanism in order to provide simple mounting of the hydro-elastic operation member to the support frame and convenient demounting therefrom. Preferably, the latching or engaging mechanism has at least one latching or retaining hook that can positively and/or frictionally engage with the support frame. This at least one latching or retaining hook may preferably extend away from a ring structure that is void of any interruptions. Preferably, the attachment device is made of one piece, in particular injection moulded from plastic.

In a preferred development of the invention the spring body has a cone-shape, at the apical end of which the flange is attached in a supporting manner, in particular by means of vulcanisation. The cone shape has a widening end at which a ring structure of the attachment device is attached in a supporting manner, in particular by means of vulcanisation. Furthermore, the cone shape has a cone-axis that is parallel to, in particular essentially coincides with, the vertical main spring damping direction of the hydro-elastic operation member.

In a preferred embodiment of the invention the flange is made of Aluminium or plastic. Preferably, the flange has a receiving space, preferably a passage, in which a separate mounting arm is firmly installed, to which the motor vehicle part is flanged. In the mounted state of the hydro-elastic bearing the mounting arm extends beyond a lateral dimension of the operation member in a lateral direction perpendicular to the driving direction.

In a preferred embodiment of the invention the hydro-elastic operation member defines a vertical main spring damping direction. The mounting arm extends perpendicularly to the main spring damping direction.

In a preferred embodiment of the invention at least one displacement limiting abutment, in particular made of an elastomer material, is attached to the flange. The spring body and preferably the at least one displacement limiting abutment is/are injection moulded as one piece.

The invention furthermore relates to a hydro-elastic bearing for a motor vehicle part like an engine unit to be connected in a vibration-damping way to a motor vehicle body, wherein the hydro-elastic bearing comprises a support frame to be mounted to the body, and a hydro-elastic operation member, in particular formed according to the invention. The operation member has a spring body, in particular made of an elastomer material, at least one hydraulic working chamber, a device for fixing the operation member to the support frame, and a flange facing the motor vehicle part for attaching the operation member, when fitted in the support frame, essentially to the motor vehicle part. The support frame defines an insertion opening such that the inserting direction of the operation member coincides with the vertical main spring damping direction, in particular such that the operation member is inserted essentially in vertical main spring damping direction from an open lower side of the support frame.

In a preferred embodiment of the invention the support frame has a U-shaped cross section, wherein the operation member is inserted as an assembly unit from the open side of the U-shaped support frame, the open side facing vertically downwards in the mounted state, and is subsequently attached to the support frame.

Finally, the invention relates to a method for fitting a hydro-elastic bearing, in particular according to the invention, for a motor vehicle part like an engine unit or an engine-gear unit to be connected to the vehicle body, wherein the hydro-elastic bearing has a vertical main spring damping direction, a support frame to be mounted to the vehicle body, and a hydro-elastic operation member, in particular formed according to the invention. The hydro-elastic operation member has a spring body, in particular made of an elastomer material, at least one hydraulic working chamber, a device for attaching the operation member to the support frame, as well as a flange facing the motor vehicle part for attaching the operation member to the motor vehicle part. The support frame is attached to the vehicle body, and the hydro-elastic operation member is inserted as an assembly unit into the support frame parallel to the main spring damping direction of the bearing, in particular from below.

Preferably, the operation member is removably inserted into the support frame to facilitate its replacement. The working chamber can be filled with a damping fluid before the operation member is inserted into the support frame.

Further characteristics, features and advantages will become apparent in the following description of a preferred embodiment in conjunction with the accompanying drawings, showing:

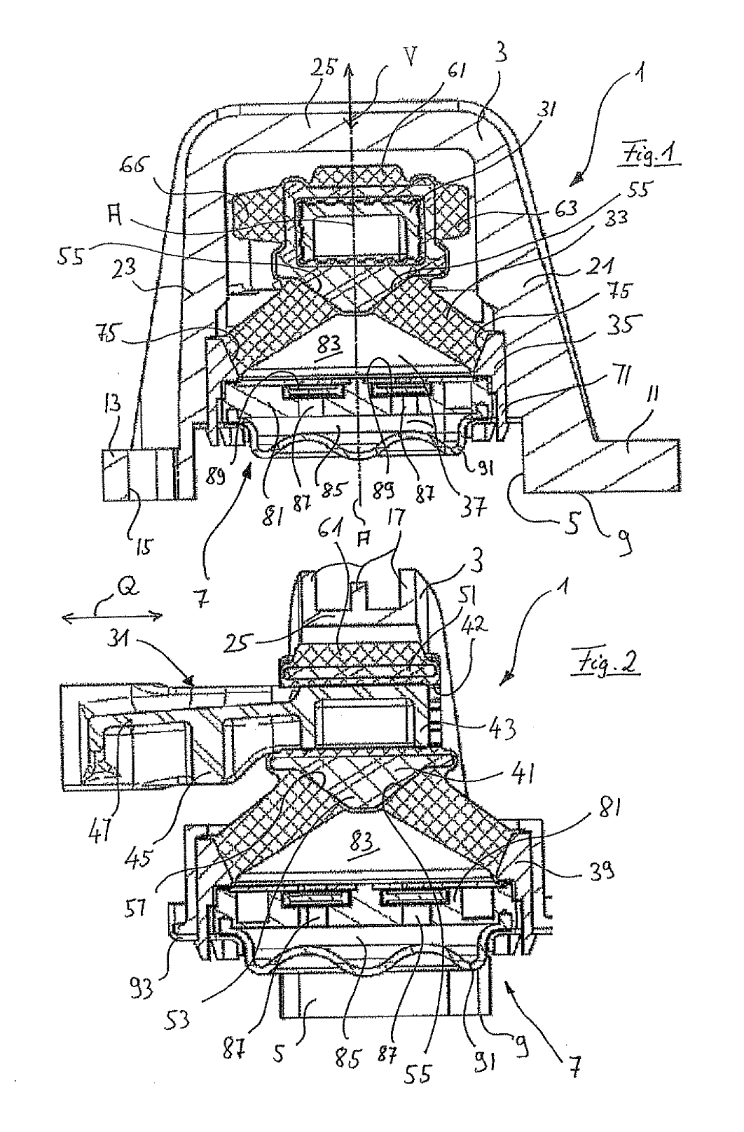

FIG. 1 a longitudinal cross section of a hydro-elastic bearing according to the invention, wherein the direction of the cut essentially corresponds to the driving direction of the motor vehicle;

FIG. 2 a cross section of the hydro-elastic bearing according to FIG. 1, wherein the direction of the cut corresponds to the transverse direction of the motor vehicle.

In FIGS. 1 and 2 the hydro-elastic bearing according to the invention is generally given the reference numeral 1. The hydro-elastic bearing 1 has a support frame 3 that has a U-shaped cross section (see FIG. 1), and the lower side 9 of which (in mounted state) is open in order to form an insertion opening 5 there for a hydro-elastic operation member.

The hydro-elastic operation member 7 is detachably inserted as an assembly unit from below (with respect to vertical direction) and embraced by the support frame 3, wherein the hydro-elastic operation member 7 reaches its position inside the support frame 3 via the insertion opening 5 which faces downwards.

The support frame 3 has support arms 11, 13 at the ends of its U-legs into which bores 15 are introduced for rigidly attaching the support frame 3 to a body of the motor vehicle (not shown in detail).

The support frame 3 comprises a circular rib structure 17 having at least three reinforcement ribs, as represented in FIG. 2.

The hydro-elastic bearing defines a vertical main spring damping direction V that coincides with an axis of symmetry A of the hydro-elastic operation member 7. Both essentially vertical U-legs 21, 23 of the U-shaped support frame 3 are connected to each other by a horizontal base 25 and extend essentially parallel to the main spring damping direction V.

At the inside of the U-legs 21, 23 and the base 25 the U-shaped support frame 3 defines an inner space that is delimited in transverse direction Q and into which the hydro-elastic operation member 7 is inserted in order to enable its performance of load oscillations within the support frame 3.

The hydro-elastic operation member 7 essentially has four main functional components, namely: a flange 31, a cone-shaped supporting spring body 33 made of elastomer material, a detachable attachment device 35, as well as a working chamber 37 filled with a damping fluid (not shown in detail).

The flange 31 has a rigid core section 41 comprising a passage 42 into which a flange arm 45 is press-fitted that extends essentially horizontally out of the core section 41 in transverse direction Q beyond the lateral dimensions of the hydro-elastic bearing 1. The area of the flange arm 45 extending beyond the lateral dimensions of the bearing serves for coupling the engine unit (not represented) to the flange 31 and is given the reference numeral 47. For this purpose the coupling area has respectively suitable bores 15 or the like.

The core section 41 has a weaker upper section 51 and a reinforced lower section 53 with an essentially triangular cross section, wherein the point-symmetrical, cone-shaped support surface 55 is inclined with respect to the transverse direction (Q) as well as to the vertical direction (V).

At the upper section 51 of the core section 41 one vertical abutment 61 and two transverse abutments 63, 65 both made of rubber are provided, which delimit a movement amplitude of the core 41 with respect to the support frame 3 through abutment against the inside of the U-legs 21, 23.

The cone-shaped elastomeric support body 33, that is essentially rotationally symmetric with respect to axis A, and at its inside partially delimits the working chamber 37, extends away from the inclined support surface 55 in a complementary shaped way.

In order to rigidly couple the hydro-elastic operation member 7 with the support frame 3 the hydro-elastic operation member 7 features the detachable attachment device 35 that has a circular ring-base 39. The detachable attachment device 35 further has a latching or engaging mechanism, and therefore has several latching hooks 71 in order to ensure a positive, rigid connection of the hydro-elastic operation member to the support frame 3, wherein also a circular latching structure can be provided for this purpose.

The attachment device 35 also has at its ring-base a circular support surface 75 which is concentric with respect to axis A and has a shape of a cone section, to which support surface the cone-shaped elastomeric support body 33 is attached by means of a vulcanised connection.

Through a radial inward displacement (with respect to transverse direction Q) of the hooks 71 for assembly of the hydro-elastic operation member, the hydro-elastic operation member 7 can be detached from the support frame 3, wherein another hydro-elastic operation member 7 can be inserted instead without damaging neither the operation member 7 nor the support frame 3.

As described above, the working chamber 37 is delimited at the upper side, facing the flange, towards the inside by the supporting spring body 33. Furthermore, the hydraulic working chamber 37 is subdivided by a channel plate 81 into an upper hydraulic working compartment 83 and a lower hydraulic working compartment 85, wherein several channels 87 are provided in the channel plate 81 to cause a resonance of the liquid in order to increase dampening. The working fluid can flow back and fourth between the working compartments 83,85 via the channels 87 upon excitation. For a certain excitation frequency resonance of the liquid will occur in the respectively dimensioned channel.

At each channel a loose decoupling disc 89 is provided that can influence the flow behaviour of the working fluid between the working compartments 83,85, whereby the dynamic stiffness (hydraulic stiffening) can be reduced.

Towards its lower side the lower working compartment 85 is to the largest extent delimited by a membrane 91, whereby the volume of the lower working compartment 85 is slightly variable. The membrane 91 is clamped at its edge to the throttling plate via a termination plate 93. The end edge of the termination plate 93 is beaded.

Depending on which operating forces and load excitations are to be expected for the hydro-elastic bearing 1, a respectively adapted hydro-elastic operation member 7 can be inserted into the prepared universal support frame 3. Should the functional data of the hydro-elastic operation member 7 not match the operating load, the operation member 7 can easily be replaced by another one by detaching the attachment device 35 from the support frame 3 and inserting the other operation member 7 into the support frame 3.

The features disclosed in the above description, the figures and the claims can be significant for the realisation of the invention individually as well as in any combination.

### LIST OF REFERENCE NUMERALS

1 hydro-elastic bearing
3 support frame
5 insertion opening
7 hydro-elastic operation member
9 lower side 11, 13 support arms
15 bores
17 rib structure
21, 23 U-legs
25 base
31 flange
33 spring body
35 attachment device
37 working chamber
39 ring-base
41 core section
42 passage
45 flange arm
47 area of the flange arm
51 upper core section
53 lower core section
55, 57 support surface
61 vertical abutment
63, 65 transverse abutments
71 latching hook
75 circular support surface
81 channel plate
83 upper working compartment
85 lower working compartment
87 channels
89 loose decoupling disc
91 membrane
93 termination plate
A axis of symmetry
V main spring damping direction (vertical direction)
Q transverse direction

1-15. (canceled)

16. A hydro-elastic operation member for a hydro-elastic bearing for mounting a motor vehicle part like an engine unit to the body of the motor vehicle, comprising:
a spring body comprising an elastomer material;
at least one hydraulic working chamber;
an attachment device for attaching the operation member to a support frame fixed to the vehicle body; and
a flange facing the motor vehicle part for attaching the operation member to the motor vehicle part,
wherein the hydraulic working chamber is delimited by components of the operation member without the support frame, and the operation member forms a component unit insertable into the support frame, and
wherein the attachment device is configured for removing the operation member, attached to the support frame, from the support frame.

17. The operation member according to claim 16, in which the attachment device is formed by a closed ring structure to which the spring body is moulded in a fluid-tight manner, wherein the spring body extends like a cone from the ring structure to the flange.

18. The operation member according to claim 16, in which the spring body has a side facing the attachment device and facing away from the flange, which side forms an inner side of the working chamber.

19. The operation member according to claim 16, in which a channel plate is disposed within the working chamber which divides the working chamber into two hydraulic working compartments that are hydraulically connected to each other by at least one channel that is formed in the channel plate and into which a loose disc comprising rubber is placed, wherein one of the compartments faces the spring body and one faces away from the spring body, wherein the working compartment facing away from the spring body is partially delimited by a flexible membrane fixed at the channel plate, at a ring structure of the attachment device, or a combination thereof.

20. The operation member according to claim 19, in which the channel plate is fixed at an inner side of a ring structure of the attachment device, is injection moulded from a plastic material, or a combination thereof.

21. The operation member according to claim 16, in which the attachment device comprises a detachable latching or engaging mechanism that includes at least one latching or retaining hook that can positively engage the support frame, frictionally engage the support frame, or a combination thereof.

22. The operation member according to claim 16, in which the attachment device comprises a detachable latching or engaging mechanism and a ring structure, and the detachable latching or engaging mechanism extends away from the ring structure.

23. The operation member according to claim 16, wherein the attachment device is injection moulded as one plastic piece.

24. The operation member according to claim 16, in which the spring body has a cone-shape (i) at the apical end of which the flange is attached in a supporting manner, (ii) at the widening end of which a ring structure of the attachment device is attached in a supporting manner, (iii) the cone-axis of which is parallel to and substantially coincides with a vertical main spring damping direction, or (iv) any combination thereof.

25. The operation member according to claim 24, wherein the attachment of the flange and the attachment of the ring structure is made with vulcanisation.

26. The operation member according to claim 16, wherein flange comprises Aluminium or plastic.

27. The operation member according to claim 16, wherein the flange defines a receiving space or a passage in which a separate mounting arm is firmly installed, and to which the motor vehicle part is flanged.

28. The operation member according to claim 16, wherein the operation member defines a vertical main spring damping direction, wherein the mounting arm extends essentially perpendicularly to the main spring damping direction and beyond a lateral dimension of the operation member in a lateral direction that is perpendicular to any driving direction of the motor vehicle.

29. The operation member according to claim 16, wherein at least one displacement limiting abutment comprising an elastomer material is attached to the flange, the spring body, or a combination thereof and the at least one displacement limiting abutment is injection moulded as one piece.

30. A hydro-elastic bearing for a motor vehicle part like an engine unit to be connected to a motor vehicle body, comprising:
a support frame to be mounted to the body, and
a hydro-elastic operation member comprising a spring body comprising an elastomer material, at least one hydraulic working chamber, a device for fixing the operation member to the support frame, and a flange facing the motor vehicle part for attaching the operation member to the motor vehicle part,
wherein the support frame defines an insertion opening such that the inserting direction of the operation member into the support frame coincides with a vertical main spring damping direction such that the operation member is inserted in vertical main spring damping direction from an open lower side of the support frame.

31. The hydro-elastic bearing according to claim 30, wherein the support frame has a U-shaped cross section, wherein the operation member is inserted as an assembly unit from the open side of the U-shape and is attached to the support frame.

32. A method for fitting a hydro-elastic bearing for a motor vehicle part like an engine unit to be connected to the vehicle body, wherein the bearing has a vertical main spring damping direction, a support frame to be mounted to the body of a motor vehicle, and a hydro-elastic operation member comprising a spring body, in particular made of an elastomer material, at least one hydraulic working chamber, a device for attaching the operation member to the support frame, and a flange facing the motor vehicle part for attaching the operation member to the motor vehicle part, the method comprising:
attaching the support frame to the vehicle body; and
inserting the hydro-elastic operation member as an assembly unit into the support frame parallel to the main spring damping direction.

33. The method according to claim 32, further comprising removably inserting the operation member into the support frame to facilitate replacement of the operation member.

34. The method according to claim 33, further comprising filling the working chamber with a damping fluid before the operation member is inserted into the support frame.
